SEQUENCE LISTING (4 sequences)

SEQ ID NO: 1 - protein, 160 aa, Betula platyphylla
MGVFTYESETTSAIPPAKLFKAFVLDADNLIPKVAPHAIKSAEIIEGNGGPGTIKKITFGEGSQFKYVKHRIDEVDHANFTYGYSVIEGDALSEVLEKISYEIKIVASHDGGSVLKSTSKYHTKGAHEIKEEQIKAGKEKAAGLFKAIEAYLLAHSDLYN

SEQ ID NO: 2 - protein, 133 aa, Betula platyphylla
MSWQTYVDEHLMCDIDGQGEELAASAIVGHDGSVWAQSSSFPQFKPQEITGIMKDFEEPGHLAPTGLHLGGIKYMVIQGEAGAVIRGKKGSGGITIKKTGQALVFGIYEEPVTPGQCNMVVERLGDYLIDQGL

SEQ ID NO: 3 - protein, 158 aa, soybean
MGVFTFEDEINSPVAPATLYKALVTDADNVIPKALDSFKSVENVEGNGGPGTIKKITFLEDGETKFVLHKIESIDEANLGYSYSVVGGAALPDTAEKITFDSKLVAGPNGGSAGKLTVKYETKGDAEPNQDELKTGKAKADALFKAIEAYLLAHPDYN

SEQ ID NO: 4 - protein, 131 aa, soybean
MSWQAYVDDHLLCEIEGNHLTHAAIIGQDGSVWAQSTNFPQFKPEEITAINNDFNEPGSLAPTGLYIGGTKYMVIQGEPGAVIRGKKGPGGVTVKKTGAALIIGIYDEPMTPGQCNMVVERLGDYLIDQGL

(19) United States
(12) Patent Application Publication
(10) Pub. No.: US 2019/0045819 A1
(43) Pub. Date: Feb. 14, 2019

(54) FERMENTED FOOD COMPOSITION PRODUCTION METHOD

(71) Applicant: KANEKA CORPORATION, Osaka-shi, Osaka (JP)

(72) Inventors: Airo TATEGAKI, Takasago-shi (JP); Hiroka MURAKAMI, Takasago-shi (JP)

(73) Assignee: KANEKA CORPORATION, Osaka-shi, Osaka (JP)

(21) Appl. No.: 15/763,731

(22) PCT Filed: Sep. 28, 2016
(86) PCT No.: PCT/JP2016/078613

§ 371 Date: Mar. 27, 2018

(30) Foreign Application Priority Data
Sep. 29, 2015 (JP) 2015-192136
Dec. 10, 2015 (JP) 2015-241087

(51) Int. Cl. A23L 11/00; A23J 3/16; A23J 3/34; A23L 33/175

(52) U.S. Cl. CPC A23L 11/09; A23J 3/16; A23J 3/346; A23L 33/175; A23Y 2280/00; A23Y 2220/00; A23Y 2240/00; A23Y 2260/00; A23V 2002/00

(57) ABSTRACT

A method for producing a fermented food composition by fermenting a food having a class-2 food allergen, includes: adding lactic acid bacteria having leucine aminopeptidase activity of 75 or more and 720 or less units, to a food having a class-2 food allergen, and fermenting the food while adjusting a pH of a mixture including the food to 4.0 or more and less than 8.5; and enzymatically treating the resulting mixture with a metalloprotease.

### TECHNICAL FIELD

The present invention relates to a method for producing a fermented food composition having reduced class-2 food allergens, and a fermented food composition which is safe and tasty and has an excellent digestive absorbability into the body.

### BACKGROUND ART

As interest in food safety rises, the increase and diversification of food allergy patients are major social problems. The food allergy has hitherto been recognized that sensitization is established by orally taking a specific protein contained in food and then symptoms such as hives and diarrhea occur when the food is taken again.

Recently, in people suffering from pollinosis or latex allergy, however, the number of people who develop an allergy such as itch or swelling (class-2 food allergy) on lips, throats or the like is increased when they take fruit, vegetables, and beans. For example, cases in which people suffering from Alnus pollinosis take food such as soybean, peach, apple, tomato, or kiwi, then develop the class-2 food allergy, and consult a doctor are increased. In addition, there are many cases in which the patients consulting a doctor with the class-2 food allergy do not recognize that they are suffering from the class-2 food allergy, and thus a problem in which they have serious allergy symptoms occurs. The contributor of the class-2 food allergy may include class-2 food allergens contained in plants, fruits and the like. It has been proved that such allergens have high homology with allergens in pollen or latex, and thus these allergens are recognized as allergens of pollen in the body of a person suffering from the pollinosis, whereby the allergy symptom is induced.

Meanwhile, a method in which allergen-reducing wheat flour is manufactured using a protease or salt water (Patent Literature 1), a method in which allergen-reducing rice is manufactured using a protease derived from lactic acid bacteria (Patent Literature 2), and a method in which soybean hypocotyl is fermented using enteric bacteria to reduce a content of allergens in soybean (Patent Literature 3) have hitherto been disclosed as a means for solving the food allergy.

In recent years, there has been an increased interest in health. In view of this, many arginine-containing foods have especially been developed, since arginine has many useful effects such as muscle augmentation, bone strengthening, fatigue recovery effect, improvement of immune function and so on.

### CITATIONS LIST

### Patent Literature

Patent Literature 1: Japanese Unexamined Patent Application Publication No. 10-108636

Patent Literature 2: Japanese Unexamined Patent Application Publication No. 11-009202

Patent Literature 3: Japanese Unexamined Patent Application Publication No. 2012-228252

### SUMMARY OF INVENTION

### Technical Problems

However, for example, in the methods described in Patent Literature 1 or 2, it is concerned that since only protease is used, the production cost becomes enormous and since saline or the like is added to foods, bitterness is caused in the fermented product obtained.

In order to solve the problems in the prior art documents, the present inventors have studied, for example, the reduction of the content of the class-2 food allergens when the food having the class-2 food allergens is fermented with lactic acid bacteria, as described in the prior art literature 3. However, they have found a problem that when the food having the class-2 food allergens is fermented with the lactic acid bacteria alone, the class-2 food allergens are not sufficiently decomposed, and the absorbency of food itself cannot be improved. Furthermore, they have also found another problem that when arginine having an effect of improving pressure ulcer and blood flow is added to food, arginine has a strong bitterness, so that if food contains a slight amount of arginine, it is affected by the bitterness derived from arginine and cannot be suitably eaten. This was problematic.

In view of the problems described above, the purpose of the present invention is to provide a method for producing a fermented food composition in which the content of a class-2 food allergen, a protein causing the class-2 food allergy, is efficiently reduced and which has a good taste, a reduced bitterness derived from arginine, and an excellent digestive absorbability into the body.

In addition, another purpose of the present invention is to provide a method capable of efficiently reducing bitterness derived from arginine even in foods or beverages to which arginine is added.

### Solutions to Problems

As a result of intensive studies to solve the above problems, the present inventors have found that a fermented food composition in which class-2 food allergens in a food are efficiently reduced and which has a good taste, a reduced bitterness derived from arginine, and an excellent digestive absorbability into the body is obtained by adding a lactic acid bacterium having a specific range of leucine aminopeptidase activity to food having a class-2 food allergen, fermenting a mixture thereof under specific pH conditions, and enzymatically treating the resulting mixture with a metalloprotease. The present invention has been completed based on these findings.

That is, the present invention provides the followings.

(1) A method for producing a fermented food composition by fermenting a food having a class-2 food allergen, the method includes:

adding lactic acid bacteria having leucine aminopeptidase activity of 75 or more and 720 or less units, to a food having a class-2 food allergen, and fermenting the food while adjusting a pH of a mixture including the food to 4.0 or more and less than 8.5; and

enzymatically treating the resulting mixture with a metalloprotease.

(2) The production method according to (1), wherein the enzymatically treating is performed before the fermenting or after the fermenting.
(3) The production method according to (1) or (2), wherein the metalloprotease is an endo-type metalloprotease.
(4) The production method according to (3), wherein the endo-type metalloprotease is derived from a filamentous fungus or from a bacterium.
(5) The production method according to (4), wherein the filamentous fungus belongs to the genus Aspergillus and the bacterium belongs to the genus Bacillus.
(6) The production method according to any one of (1) to (5), wherein a time for the enzymatically treating is 4 hours or less.
(7) The production method according to any one of (1) to (6), wherein an amount of an enzyme to be added during the enzymatically treating is 10 U/g or more and 1200 U/g or less per protein weight in the food having the class-2 food allergen.
(8) The production method according to any one of (1) to (7), wherein the lactic acid bacteria are at least one type of bacteria selected from the group consisting of lactic acid bacteria each belonging to the genera Lactobacillus, Lactococcus, Leuconostoc, Pediococcus, and Enterococcus.
(9) The production method according to any one of (1) to (8), wherein the class-2 food allergen includes an amino acid sequence having at least 20% sequence identity with an amino acid sequence of BetV1 and/or BetV2.
(10) The production method according to any one of (1) to (9), wherein the food having the class-2 food allergen is a soybean and/or a soybean processed food.
(11) A method for reducing bitterness of arginine by adding, to 1 mg of arginine, 5 mg or more and 1000 mg or less of the fermented food composition obtained by the production method as set forth in any one of (1) to (10).
(12) A food and drink containing 5 mg or more and 1000 mg or less of the fermented food composition obtained by the method as set forth in any one of (1) to (10), relative to 1 mg of arginine.

### Advantageous Effects of Invention

According to the production method of the present invention, by using a lactic acid bacterium having a leucine aminopeptidase activity of 75 units or more and 720 units or less and a metalloprotease, class-2 food allergens are efficiently reduced, so that a fermented food composition having an excellent digestive absorbability into the body can be obtained. In addition, since not only metalloprotease but also lactic acid bacteria are used, it is possible to provide a fermented food composition which has a good taste, a reduced influence on taste by the metalloprotease and a reduced bitterness derived from arginine.

Further, since the class-2 food allergens are sufficiently reduced in the fermented food composition obtained by the production method of the present invention, such composition can be safely ingested by a person suffering from pollinosis and latex allergy. In addition, since the fermented food composition has a good taste and a reduced bitterness derived from arginine, and is excellent in digestive absorbability into the body, it can be used as a substitute for foods having class-2 food allergens.

Moreover, in the present invention, by using the fermented food composition, it is possible to efficiently reduce arginine-derived bitterness in foods and beverages to which arginine is added, so that in various foods and beverages, it is possible to provide functional foods enhanced with arginine.

### BRIEF DESCRIPTION OF DRAWINGS

FIG. 1 is a graph showing the results of gel staining and densitogram of SDS-PAGE of the Inventive Product 1 in Examples (upper FIG.) and the results of gel staining and densitogram of SDS-PAGE of Comparative Product 3 (lower FIG.).

### DESCRIPTION OF EMBODIMENTS

Hereinafter, the present invention will be described in detail.

The present invention relates to a method for producing a fermented food composition by fermenting a food having a class-2 food allergen.

The class-2 food allergen in the present invention refers to a protein having a high sequence identity of an amino acid sequence with an allergen contained in pollen or latex and is mainly contained in plants, fruits or the like. If the sequence identity with a specific allergen is 20% or more, an allergy symptom may sometimes be induced, and thus the class-2 food allergen in the present invention refers to a protein having 20% or more of the sequence identity of the amino acid sequence with the allergen contained in the pollen or the latex.

Specifically, the following proteins may be included as the class-2 food allergen. There are exemplified a protein containing an amino acid sequence having 20% or more, preferably 30% or more, more preferably 40% or more, still more preferably 47% or more, of a sequence identity with the amino acid sequence of BetV1 described in SEQ ID NO: 1, which is a major antigen of Betula alba pollen; and a protein containing an amino acid sequence having 20% or more, preferably 50% or more, more preferably 60% or more, still more preferably 74% or more, of a sequence identity with the amino acid sequence of BetV2 described in SEQ ID NO: 2, which is a major antigen of Betula alba pollen. More specific class 2 food allergens include PR-10 family proteins and profilin family proteins having 20% or more of a sequence identity with the amino acid sequence of BetV1 and/or BetV2. Especially, it may include Glym4, which is a PR-10 family protein, has 47% of a sequence identity with the amino acid sequence of BetV1, and contains an amino acid sequence described in SEQ ID NO: 3, which is a protein derived from soybean; and Glym3, which is a profilin family protein, has 74% of a sequence identity with the amino acid sequence of BetV2, and contains an amino acid sequence described in SEQ ID NO: 4, which is a protein derived from soybean.

Proteins containing an amino acid sequence having 85% or more, more preferably 90% or more, still more preferably 95% or more, of a sequence identity with the amino acid sequence of Glym4 or Glym3 are included in the class-2 food allergens in the present invention.

The food having the class-2 food allergens in the present invention refers to food which induces class-2 food allergy in human beings. The food which induces the class-2 food allergy may include, for example, Rosaceae food such as apple, peach, strawberry, pear, loquat, or cherry; Cucurbitaceae food such as melon, watermelon, or cucumber; soybean, kiwi, orange, yam, mango, avocado, hazelnut (hazel), carrot, celery, potato, tomato, burdock, walnut, almond, coconut, peanut, lychee, onion, rice, wheat, mustard, paprika, coriander, red pepper, cumin, and the like. Of these, apple, peach, strawberry, pear, loquat, cherry, melon, watermelon, cucumber, soybean, kiwi, orange, yam, mango, avocado, hazelnut (hazel), carrot, celery, potato, tomato, burdock, walnut, almond, coconut, peanut, lychee, mustard, paprika, coriander, and red pepper are preferable, which are food containing a large amount of proteins containing an amino acid sequence having at least 20% of a sequence identity with the amino acid sequence of BetV1 and/or BetV2, which is a major antigen of the Betula alba pollen, because about half number of people suffering from the Betula alba pollinosis develop the class-2 food allergy. As the food having the class-2 food allergens in the present invention, particularly preferred are soybean, wheat, and a processed food thereof, whose annual consumption is large and which are reported to show a serious allergy symptom such as anaphylactic shock when a person suffering from the Betula alba pollinosis takes it. The food having the class-2 food allergens may be used alone or as a mixture of two or more kinds thereof.

For the food having the class-2 food allergens used in the present invention, the vegetables, the fruits, and the like listed above may be processed into: extracts obtained by extraction with water, hot water, or an organic solvent usable for food; non-concentrates that are squeezed, ground, crushed, or treated with an enzyme; concentrates; diluted products; and dried products.

In the present invention, an optional component may be suitably added to the food having the class-2 food allergens. The optional component may include saccharides, yeast extracts, meat extracts, vitamins, inorganic salts, peptides, amino acids, and the like.

Among the amino acids, it is preferable to add arginine having an effect of improving pressure sores and blood flow. By using the method for producing a fermented food composition of the present invention, a fermented food composition having a good taste with a reduced bitterness derived from arginine can be obtained.

The production method of the present invention is explained in detail below.

The production method of the present invention includes a step of adding a lactic acid bacterium having at least a leucine aminopeptidase activity of 75 units or more and 720 units or less to a food having a class-2 food allergen, and fermenting the resulting food mixture while the pH of the mixture is adjusted to 4.0 or more and less than 8.5 (hereinafter also referred to as a step (a)).

The leucine aminopeptidase activity in the present invention can be measured in accordance with a method of Matsutani et. al. (J. Med. Technol., 11, 300, 1967) wherein a case in which a difference in an absorbance at 540 nm between a reaction liquid and a blank per 1 g of wet bacterial cells of the lactic acid bacteria (a difference in an absorbance at 540 nm/wet bacterial cells (g)) is 1 is defined as 1 unit.

Microorganisms other than lactic acid bacteria also have the leucine aminopeptidase and examples of such microorganisms include Aspergillus oryzae and Bacillus subtilis.

The lactic acid bacteria used in the production method of the present invention are lactic acid bacteria having a specific leucine aminopeptidase activity, and the leucine aminopeptidase activity is 75 units or more, preferably 77 units or more, more preferably 166 units or more, still more preferably 368 units or more. The upper limit of the leucine aminopeptidase activity is 720 units or less, preferably 719 units or less, more preferably 589 units or less. If the leucine aminopeptidase activity of lactic acid bacteria is less than 75 units, the class-2 food allergen is not reduced, or the fermentation time for reducing the class-2 food allergen becomes undesirably longer. When the lactic acid bacteria have the leucine aminopeptidase activity of 720 units or more, bitterness may occur in the resultant fermented food composition, which is not desirable.

The lactic acid bacteria used in the production method of the present invention is not particularly limited so long as the lactic acid bacteria have the leucine aminopeptidase activity within the range described above, and may include, for example, lactic acid bacteria belonging to Lactobacillus, Lactococcus, Leuconostoc, Pediococcus, Enterococcus, Streptococcus, Bacillus, and Bifidobacterium, and the like.

More specific examples may include the followings:
(1) Lactobacillus helveticus K-4 strain (which was deposited as FERM P-12249 at Fermentation Research Institute, Patent Microorganisms Depositary on May 15, 1991, and was accepted as an accession number FERM ABP-12249 at National Institute of Technology and Evaluation, Patent Microorganisms Depositary (NITE-IPOD), 2-5-8, Kazusakamatari, Kisarazu-shi, Chiba-ken, 292-0818, Japan, on Sep. 15, 2016 under the provisions of the Budapest Treaty, and transferred to international deposit as an accession number FERM BP-12249);
(2) Pediococcus acidilactici R037 strain (which was internationally deposited as an accession number NITE BP-900 at National Institute of Technology and Evaluation, Patent Microorganisms Depositary (NPMD), 2-5-8, Kazusakamatari, Kisarazu-shi, Chiba-ken, 292-0818, Japan, on Feb. 10, 2010);
(3) Pediococcus sp. 379 strain (which was deposited as an accession number NITE P-01773 at NPMD on Dec. 4, 2013, and transferred to international deposit as an accession number NITE BP-01773 on Nov. 17, 2014 under the provisions of the Budapest Treaty);
(4) Pediococcus sp. 380 strain (which was deposited as an accession number NITE P-01772 at NPMD on Dec. 4, 2013, and transferred to international deposit as an accession number NITE BP-01772 on Nov. 17, 2014 under the provisions of the Budapest Treaty);
(5) Streptococcus sp. 462 strain (which was deposited as an accession number NITE P-01771 at NPMD on Dec. 4, 2013, and transferred to international deposit as an accession number NITE BP-01771 on Nov. 17, 2014 under the provisions of the Budapest Treaty);
(6) Lactobacillus helveticus 28 strain (which was deposited as an accession number NITE P-02154 on Oct. 30, 2015 at NPMD, accepted as an accession number NITE ABP-02154 at NPMD on Sep. 15, 2016 under the provisions of the Budapest Treaty and transferred to international deposit as an accession number NITE BP-02154); and the like.

In the step (a) of the present invention, the food having the class-2 food allergens can be previously sterilized before the addition of the lactic acid bacteria. The sterilization method may be appropriately selected depending on the kind of the food used, and may include, for example, but is not limited to, high-temperature sterilization methods such as UHT (ultrahigh temperature sterilization), retort sterilization methods, sterilization methods with electromagnetic wave, high-temperature vacuum sterilization methods, ozone sterilization methods, sterilization methods using electrolyzed water, indirect heating sterilization methods, and the like.

In the step (a) of the present invention, the fermentation temperature is not particularly limited so long as the temperature is suitable for the growth of the lactic acid bacteria, and the fermentation temperature is, for example, from 15 to 45° C., preferably from 25 to 40° C., more preferably from 30 to 37° C.

In the step (a) of the present invention, the pH in the fermentation of the food having the class-2 food allergens by adding the lactic acid bacteria thereto is 4.0 or more, preferably 4.4 or more, more preferably 5.5 or more. The upper limit of the pH of a mixture containing the food having the class-2 food allergens in the step (a) of the present invention is less than 8.5, more preferably 7.5 or less, still more preferably 6.5 or less. When the pH of the mixture containing the food is less than 4.0, the leucine aminopeptidase activity will become weak and the desired fermented food composition may sometimes not be obtained, which is not preferable. When the pH of the mixture containing the food is 8.5 or more, the proliferative property of lactic acid bacteria will deteriorate and a desired fermented food composition cannot be obtained in some cases, which is not preferable.

In addition, the mixture containing the foods means a liquid composition obtained by mixing the food having the class-2 food allergens and lactic acid bacteria. The food having the class-2 food allergens includes those which have been subjected to enzyme treatment with a metalloprotease.

The pH adjustment in the step (a) of the present invention may be performed as necessary so that the pH of the food is 4.0 or more and less than 8.5 during the fermentation. When the pH is adjusted, the compound used is not particularly limited so long as it can be used for food, and a divalent metal compound, sodium hydroxide, sulfuric acid, ammonia, citric acid, lactic acid, and the like can be used because they can be taken as the food. These compounds may be used in combination. The divalent metal compound, which can be used for the food, may include magnesium compounds such as magnesium acetate, magnesium carbonate, magnesium stearate, magnesium oxide, magnesium silicate, and trimagnesium phosphate; calcium compounds such as calcium citrate, calcium carbonate, calcium dihydrogen pyrophosphate, tricalcium phosphate, calcium stearate, and calcium silicate; and zinc compounds such as zinc gluconate and zinc sulfate. The method for adjusting the pH is not particularly limited and may be a method in which a pH of the mixture containing the food is measured with a pH electrode and automatic supply is performed, or a method in which an insoluble divalent metal compound is previously added in a neutral range of compounds such as calcium carbonate or magnesium carbonate before the fermentation.

The fermentation time in the step (a) of the present invention may be appropriately decided depending on the kind and the growth state of the lactic acid bacteria and is not particularly limited. Specifically, the fermentation time is preferably 1 hour or more and 36 hours or less, more preferably 1 hour or more and 24 hours or less, still more preferably 1 hour or more and 12 hours or less. When the fermentation time is 1 hour or more and 36 hours or less, the taste of the fermented food composition obtained becomes better.

In the step (a), it is enough that the fermentation is completed for the fermentation time described above, but the fermentation time necessary for class-2 food allergens to be reduced by 40% or more than those before the fermentation may be set. The amount of the class-2 food allergens in the food before the fermentation or in the fermented food composition may be measured according to the method described in Examples described below.

In the step (a), from the viewpoint of improving the efficiency of reducing class-2 food allergens, a divalent metal compound may be added to a food having a class-2 food allergen. The divalent metal compound may include compounds containing any of alkaline earth metals, metals of Group 11 in the periodic table, and metals of Group 12 in the periodic table. Of these, magnesium compounds such as magnesium acetate, magnesium carbonate, magnesium stearate, magnesium oxide, magnesium silicate, and trimagnesium phosphate; calcium compounds such as calcium citrate, calcium carbonate, calcium dihydrogen pyrophosphate, tricalcium phosphate, calcium stearate, and calcium silicate; and zinc compounds such as zinc gluconate and zinc sulfate are preferable, because they can be usually taken as food. Instead of the divalent metal compound, a food containing at least one or more metal compounds selected from the group consisting of calcium, magnesium and zinc in a high content may be added.

In the present invention, the divalent metal compound is added in an amount of preferably 2 mmol/L or more, more preferably 20 mmol/L or more, relative to a raw material, i.e., the food having the class-2 food allergens. The upper limit of the addition amount of the divalent metal compound is preferably 1 mol/L or less, more preferably 300 mmol/L or less. When the divalent metal compound is added in an amount of more than 1 mol/L, the taste undesirably becomes worse, for example, bitter taste peculiar to the divalent metal ion, or rough food texture appears.

When the addition amount of the divalent metal compound is measured, the food having the class-2 food allergens is in the state of a liquid composition for fermentation of the food by the lactic acid bacteria.

After completion of the step (a), lactic acid bacteria may be sterilized.

As a method for sterilizing lactic acid bacteria, conventional methods in foods may be used, including, but not limited to, low temperature sterilization method, retort sterilization method, filter sterilization method, high pressure sterilization, microwave sterilization method and the like.

Moreover, the production method of the present invention includes a step (hereinafter also referred to as a step (b)) of enzymatically treating the resulting mixture with a metalloprotease. In the present invention, the step (b) may be performed either before or after the step (a).

The metalloprotease is a protease in which a metal is involved in catalysis, and examples thereof include an exo-type metalloprotease and an endo-type metalloprotease. The exo-type metalloprotease refers to one that hydrolyzes a peptide bond from the terminal of the amino acid sequence of a protein molecule to break down a protein or a high molecular weight peptide into a low molecular weight peptide. In the exo-type metalloprotease, there are a type that cleaves a protein serving as a substrate from the N-terminal, and a type that cleaves a protein serving as a substrate from the C-terminal.

The endo-type metalloprotease refers to one that hydrolyzes peptide bonds inside protein molecules to break down a protein or a high molecular weight peptide into a low molecular weight peptide.

Examples of the endo-type metalloprotease include an endo metalloprotease derived from filamentous fungi or bacteria.

The filamentous fungi include those belonging to the genera Aspergillus, Rhizopus, and the like.

The bacteria include those belonging to the genera Bacillus, Streptomyces, and the like.

Specific examples of the endo-type metalloproteases include “Protin SD-NY10”, “Thermoase C100”, “Protease P3 SD” and “Protease MSD”, which are manufactured by Amano Enzyme Inc., “Nucleicin” manufactured by HBI Enzymes Inc., “Orientase” series, which are manufactured by HBI Enzymes Inc. and the like.

Among these, “Protin SD-NY10”, “Thermoase C100” and “Protease P3SD”, manufactured by Amano Enzyme Inc., are preferable from the viewpoint that the taste of the obtained fermented food composition is good in addition to the decomposing action of proteins.

The endo-type metalloprotease may be used alone or in combination with two or more kinds thereof or may be combined with another protease.

From the viewpoint of improving digestive absorbability, it is preferable to adjust the addition amount of the enzyme in the enzyme treatment using the metalloprotease, to 10 U/g or more and 1200 U/g or less per weight of protein in the food having a class-2 food allergen.

The lower limit value of the addition amount of the enzyme is more preferably 20 U/g or more, 30 U/g or more, 40 U/g or more, 50 U/g or more, 60 U/g or more, 70 U/g or more, 80 U/g or more, 90 U/g or more, 100 U/G or more, 110 U/g or more, 120 U/g or more, 130 U/g or more, 140 U/g or more, or 150 U/g or more. In addition, the upper limit value of the addition amount of the enzyme is more preferably 1100 U/g or less, 1000 U/g or less, 900 U/g or less, 800 U/g or less, 700 U/g or less, 600 U/g or less, 500 U/g or less, 400 U/g or less, 300 U/g or less, 290 U/g or less, 280 U/g or less, 270 U/g or less, 260 U/g or less, 250 U/g or less, 240 U/g or less, 230 U/g or less, 220 U/g or less, 210 U/g or less, or 200 U/g or less.

The “U” is an abbreviation for “unit”. The U/g may be measured based on a conventional method or may be calculated from those described in the catalog when a commercially available metalloprotease is used.

The time and temperature of the enzyme treatment in the step (b) cannot be flatly limited depending on the kind, state of the food having a class-2 food allergen as a raw material, and the addition amount of the enzyme. For example, the time and temperature may be adjusted so that the original taste of the food should not be impaired by the too much advanced decomposition of the protein in the enzyme treatment. Specifically, the time for the enzyme treatment is preferably 4 hours or less, more preferably 3 hours or less, from the viewpoint of keeping the taste of the obtained fermented food composition good regardless of the type and amount of raw materials and enzymes. The lower limit of the time for the enzyme treatment is preferably 10 minutes or more, 20 minutes or more, 30 minutes or more, 40 minutes or more, 50 minutes or more, or 1 hour or more from the viewpoint of obtaining the effect by the enzyme treatment. The temperature for the enzyme treatment cannot be flatly limited by the enzyme to be used, but for example, the temperature for the enzyme treatment in the case of using Protin SD-NY10 is preferably 30° C. or more, 40° C. or more, 50° C. or more, or 60° C. or more. The upper limit of the temperature for the enzyme treatment is preferably 70° C. or less, particularly preferably 65° C. or less. When the temperature for the enzyme treatment is less than 30° C., the enzyme activity decreases, whereas if it exceeds 70° C., the enzyme activity decreases as well as enzyme stability decreases, such being undesirable.

As a production method of the present invention, specifically, the following steps are performed when the step (b) is performed before the step (a).

Such a production method includes:

a step of enzymatically treating a food having a class-2 food allergen with a metalloprotease (step (b)), and then,
a step of adding lactic acid bacteria having at least leucine aminopeptidase activity of 75 units or more and 720 units or less to the enzymatically treated food having a class-2 food allergen and fermenting the food while adjusting the pH of the food to 4.0 or more and less than 8.5 (step (a)).

On the other hand, when the step (b) is performed after the step (a), specifically, the following steps are performed:

a step of adding lactic acid bacteria having at least leucine aminopeptidase activity of 75 units or more but 720 units or less to a food having a class-2 food allergen and fermenting the food while adjusting the pH of the food to 4.0 or more and less than 8.5 (step (a)), and then

a step of enzymatically treating the lactic acid bacteria fermented product obtained in the above step with a metalloprotease (step (b)).

Since the enzyme treatment with the metalloprotease is a substrate specific enzyme reaction, it is possible to carry out a desired decomposition by treating a food having a class-2 food allergen in advance with an enzyme, but it is possible to carry out the step (b) after the step (a) from the viewpoint of efficiently producing a fermented food composition.

After the step (b), a treatment for inactivating the enzyme may be carried out.

As a method for inactivating the enzyme, a usual method in foods may be used, and examples thereof include, but are not limited to, a method of heating, a method of pressurization, a method using an alcohol having 1 to 4 carbon atoms, a method using supercritical carbon dioxide, a method of changing a pH, and the like.

According to the recovery of the fermented food composition in the production method of the present invention, the fermented food composition may be filled in a container as it is or after the composition is subjected to a treatment which is usually used for food, such as sterilization or homogenization. If necessary, concentration, such as centrifugal separation, squeezing, or filtration, or drying, such as lyophilization or spray-drying, may be performed. A separation treatment using an ion exchange membrane, an extraction treatment using a solvent, or the like may be performed to reduce and concentrate a specific substance. The method for producing a fermented food composition of the present invention may be carried out in the same factory or in a different factory for each step.

Furthermore, the present invention relates to a method for producing an arginine-enhanced fermented food composition including a step of adding arginine to a fermented food composition obtained by the above-mentioned method for producing a fermented food composition.

The amount of arginine to be added is not particularly limited as long as it is an amount capable of improving pressure ulcer and blood flow of arginine, but from the viewpoint of exhibiting good taste and arginine functionality, it is preferable to add arginine in a range of at least 0.1 mg, at least 0.2 mg, at least 0.3 mg, at least 0.4 mg, at least 0.5 mg, at least 0.6 mg, at least 0.7 mg, at least 0.8 mg, at least 0.9 mg, at least 1 mg, at least 2.5 mg, or at least 5 mg, and 20 mg or less, 19 mg or less, 18 mg or less, 17 mg or less, 16 mg or less, 15 mg or less, 14 mg or less, 13 mg or less, 12 mg or less, 11 mg or less, or 10 mg or less, with respect to 100 mg of the fermented food composition.

The fermented composition, obtained by the production method of the present invention, has the class-2 food allergens in a remarkably reduced content compared to that of the starting food, is tasty because of the fermentation by the lactic acid bacteria, and thus can be ingested as it is. If necessary, other starting materials usually used for food may be added. The other starting materials usually used for food may include, for example, an excipient, a disintegrator, an emulsifier, a stabilizer, a buffering agent, a thickening agent, a perfume, and the like. These substances may be appropriately mixed according to the use form by those skilled in the art, and the amount of the other starting materials added may be designed according to the product form by those skilled in the art.

The fermented food composition obtained by the production method of the present invention can be used for foods and drinks, functional foods, medicines, feeds, and the like.

For example, when the food containing the fermented food composition is daily taken as food and drink, the form thereof is not particularly limited, and may include common form of foods and drinks such as baked goods, cakes, pies, cookies, jellies, Japanese confectioneries, snack foods, fried confectioneries, chocolates and chocolate confectioneries, rice confectioneries, roux, sole, sauce, toppings, ice confectioneries, noodles, bakery mixes, fried foods, meat processed products, other processed products such as tofu and konnyaku, fish paste products, frozen food such as frozen entrees, frozen livestock food, and frozen agricultural products, cooked rice, jam, cheese, cheese food, cheese-like food, chewing gum, candies, fermented milk, canned food, beverages, and the like. When the food containing the fermented food composition is used as functional food or medicine, the dosage form thereof is not particularly limited, and it may include, for example, capsules, syrups, tablets, pills, powders, granules, drinkable preparations, injections, infusions, nasal drops, eye drops, suppositories, patches, sprays, and the like. In the formulation, other pharmaceutically acceptable preparations such as an excipient, a disintegrator, a lubricant, a binding agent, an antioxidant, a coloring agent, an aggregation preventing agent, an absorption promoter, a solubilizer, and a stabilizer may be appropriately added to prepare such a dosage form. When the food containing the fermented food composition is used as a feed, starting materials usually used for mixed feed may be appropriately added according to the rearing environment such as the kind of animals, the stage of animal growth, or, the area. The starting material may include, for example, grains and processed grains (corn, milo, barley, wheat, rye, oat, millet, wheat flour, wheat germ powder, etc.); chaff and bran (wheat bran, rice bran, corn gluten feed, etc.); plant origin oil cakes (soybean oil cake, sesame oil cake, cottonseed oil cake, peanut oil cake, sunflower oil cake, safflower oil cake, etc.); animal origin starting materials (skim milk, fish meal powder, meat and bone meal powder, etc.); minerals (calcium carbonate, calcium phosphate, sodium chloride, silicic acid anhydride, etc.); vitamins (vitamin A, vitamin D, vitamin E, vitamin K, vitamin B1, vitamin B2, vitamin B6, vitamin B12, calcium pantothenate, nicotinic acid amide, folic acid, etc.); amino acids (glycine, methionine, etc.); yeasts such as beer yeast; fine powders of an inorganic substance (crystalline cellulose, talc, silica, muscovite, zeolite, etc.); and the like. The feed in the present invention may be mixed with feed additives such as an excipient, an extender, a binding agent, a thickener, an emulsifier, a coloring agent, a perfume, a food additive, and a seasoning, and if necessary, other components (such as an antibiotic, a sterilizer, an anthelmintic, and a preservative). The form of the feed is not particularly limited and may include, for example, powders, granules, pastes, pellets, capsules (hard capsules and soft capsules), tablets, and the like. Animals to which the feed is fed are not particularly limited and may include, for example, domestic animals such as cattle, horses, pigs, and sheep; domestic fowls such as chickens (including both of broilers and hens), turkeys, and ducks; experimental animals such as mice, rats, and guinea pigs; pets such as dogs, cats, birds, reptiles, and amphibians; and the like.

In addition, the fermented food composition obtained by the production method of the present invention can be used for masking offensive taste such as bitterness.

Among these, while the fermented food composition is useful as a physiologically active substance, bitterness of arginine can be remarkably reduced by adding 5 mg or more and 1000 mg or less of the fermented food composition to 1 mg of arginine having a strong bitter taste.

From the viewpoint of reducing the bitterness of arginine, the lower limit of the addition amount of the fermented food composition is preferably 6 mg or more, 7 mg or more, 8 mg or more, 9 mg or more, 10 mg or more, 11 mg or more, 12 mg or more, 13 mg or more, 14 mg or more, 15 mg or more, 16 mg or more, 17 mg or more, 18 mg or more, 19 mg or more, or 20 mg or more, with respect to 1 mg of arginine. In addition, from the viewpoint of sufficiently exhibiting the effect of arginine, the upper limit of the addition amount of the fermented food composition is preferably 900 mg or less, 800 mg or less, 700 mg or less, 600 mg or less, 500 mg or less, 400 mg or less, 300 mg or less, 200 or less, 150 mg or less, or 100 mg or less, with respect to 1 mg of arginine.

In the method of reducing the bitterness of arginine according to the present invention, the arginine and the fermented food composition may be, for example, mixed in advance, or arginine or a fermented food composition may be added separately to other base foods and drinks.

By using the method of reducing the bitterness of arginine, various foods and drinks, particularly those in which it was difficult to add arginine due to its strong feeling of the bitterness, can be used as an arginine-enhanced functional food.

### EXAMPLES

Detailed Examples are given below for specifically describing the present invention, but the present invention is not limited to these Examples.

### <Preparation Method of Fermented Soybean Milk>

Commercially available dried soybean was washed with water and immersed in a 9-fold amount of water for 3 hours. After that, the soybean was pulverized in a mixer into a paste, which was filtered with a gauze to prepare soybean milk. To the soybean milk were added 1% of glucose and 1.5% (150 mmol/L) of calcium carbonate, and the mixture was sterilized at 90° C. for 15 minutes. Then, lactic acid bacteria were inoculated to the mixture and fermentation was performed at 37° C. for 24 hours with stirring.

### <Calculation Method of Decreasing Rate of Glym4>

The respective 100 μL of the soybean milk before and after the fermentation was individually diluted 100-fold with PBS (10 mM phosphate buffer and 150 mM NaCl, pH 7.4), and was added to a “96-well ELISA plate” (manufactured by Iwaki Co., Ltd.). The respective mixture was left to stand at 37° C. for 30 minutes to fix it on the plate. After the soybean milk obtained before and after the fermentation was removed, 200 μL of a blocking agent “BlockingOne” (trade name; manufactured by Nacalai Tesque, Inc.), which was diluted 5-fold with distilled water, was added to each well, and the mixture was left to stand at room temperature for one hour. After the each well was washed three times with a washing buffer “PBST” (10 mM phosphate buffer, 150 mM NaCl, and 0.05% Tween (registered trademark) 20, pH 7.4), 50 μL of Glym4-specific rabbit antisera, which were diluted 1000-fold with an antibody diluent “Can Get Signal (registered trademark) Solution 1” (trade name; manufactured by Toyobo Co., Ltd.), were added to the each well, which was left to stand at 37° C. for one hour.

After each well was washed with PBST three times, 504, of peroxidase-labeled goat anti-rabbit IgG antibodies (manufactured by Thermo Fisher Scientific Inc.), which were diluted 1000-fold with an antibody diluent “Can Get Signal (registered trademark) Solution 2” (trade name, manufactured by Toyobo Co., Ltd.), were added to the each well, which was left to stand at 37° C. for one hour. After the each well was washed with PBST five times, 100 μL of “ELISA POD substrate TMB kit” (trade name; manufactured by Nacalai Tesque, Inc.) was added to the each well, which was left to stand at room temperature for 15 minutes (a color reaction). Then, 100 μL of 1M sulfuric acid was added to the each well (stopping of the coloring), and an absorbance at 450 nm was measured. Using the absorbance in the soybean milk before the fermentation and the absorbance in the soybean milk after the fermentation, a decreasing rate of Glym4 was calculated according to the equation (1):

$$Decreasing rate of Glym 4 ( \% ) = \{ 1 - \frac{[ \begin{matrix}Absorbance of soybean milk at 450 nm \\ before fermentation\end{matrix} ]}{[ \begin{matrix}Absorbance of soybean milk at 450 nm \\ after fermentation\end{matrix} ]} \} \times 100 \qquad Equation ( 1 )$$

### <Calculation Method of Leucine Aminopeptidase Activity of Lactic Acid Bacteria>

Lactic acid bacteria were cultured in 10 mL of an MK-1 medium (0.5% yeast extract, 1% peptone, and 1% glucose, pH 6.8), which had been sterilized, at 37° C. for 24 hours, and bacterial cells were collected by centrifugal separation. The bacterial cells were washed with 30 mL of 50 mM phosphate buffer (0.4 mM EDTA-3 mM DTT, pH 6.2), and the centrifugal separation was performed again to obtain wet bacterial cells. The wet bacterial cells were weighed by using an electronic balance (manufactured by Sartorius) to measure a weight of the wet bacterial cells. After that, a suspension in which the bacterial cells were suspended in 30 mL of 50 mM phosphate buffer was subjected to a leucine aminopeptidase activity measurement. To 0.1 mL of the bacterial cell suspension was added 2 mL of 0.2 mM L-leucine-β-naphthylamide solution (L-Leucine-β-naphthylamide/50 mM phosphate buffer), which was subjected to enzymatic reaction at 37° C. for one hour. 1 mL of 0.23N HCl/ethanol solution was added to the enzymatic reaction liquid to stop the enzymatic reaction. A 0.06% p-dimethylaminocinnamaldehyde/ethanol solution was added thereto, which was incubated at 37° C. for 30 minutes, and then an absorbance was measured at 540 nm to obtain the absorbance of the reaction liquid. An absorbance of a blank was measured in the same operation as above except that 2 mL of 50 mM phosphate buffer was used instead of 2 mL of the 0.2 mM L-leucine-β-naphthylamide solution. Using the obtained absorbance of the blank and that of the reaction liquid at 540 nm and the weight of the wet bacterial cells, the leucine aminopeptidase activity of the lactic acid bacteria was calculated according to the equation (2):

$$\begin{matrix}Leucine aminopeptidase \\ activity of lactic acid \\ bacteria ( unit )\end{matrix} = \frac{\begin{matrix}[ Absorbance of reaction liquid at 540 nm ] - \\ [ Absorbance of blank at 540 nm ]\end{matrix}}{[ Weight of wet bacterial cells ]} \times \frac{[ \begin{matrix}Weight of wet \\ bacterial cells\end{matrix} ] + 30}{0.1} \qquad Equation ( 2 )$$

### <Selection of Lactic Acid Bacteria>

From the lactic acid bacteria separated from the food, lactic acid bacteria having a leucine aminopeptidase activity of 50 units or more were selected by using the activity measurement method described above.

### <Sensory Evaluation of Fermented Soybean Milk>

The fermented soybean, which was adjusted to a temperature of 10° C., was tasted by 5 panelists, and sensory evaluations about soybean odor and taste was performed. The soybean odor was evaluated as follows: A case where there was no soybean odor was evaluated as “◯ (circle)”, a case where there was slight soybean odor was evaluated as “Δ (delta)”, and a case where there was soybean odor was evaluated as “x (cross)”. The taste was evaluated as follows: A case where the taste was good was evaluated as “◯ (circle)”, a case where the taste was not so good was evaluated “Δ (delta)”, and a case where the taste was not good was evaluated as “x (cross)”.

### <Evaluation of Protein Decomposition>

A food having a class-2 food allergen was subjected to an SDS-polyacrylamide gel electrophoresis (SDS-PAGE), and the gel subjected to protein staining was taken in with a densitometer [Image Quant LAS 4000 (manufactured by GE Healthcare)] and analysis was made with an image analysis software (Image Quant TL (manufactured by GE Healthcare)). From the densitogram of each lane, the staining intensity of each band with respect to the total staining intensity was calculated for each lane, and the molecular weight when the value obtained by adding the staining intensity of each band in order of the molecular weight was 50% was calculated and used as the median value of the molecular weight. The median value of the molecular weight is the value at the center when all the data are arranged and therefore such median value is difficult to be influenced by the outlier (for example, non-degraded macromolecular proteins) and is suitable for assessing the extent of protein decomposition. The SDS-PAGE was carried out by “Laemmli method (Nature, 227, 680-685; 1970)”. Using “e-PAGEL: E-R1020L (manufactured by ATTO Corp.)” as an electrophoresis gel (gradient gel at 10 to 20% concentration) and “Precision PLUS protein standard (manufactured by Bio-Rad)” as a protein molecular weight marker, the other reagents were conformed to the Laemmli method. After completion of electrophoresis, proteins were stained with “Bio-Safe Coomassie Stain (manufactured by Bio-Rad)”.

### Example 1<Decreasing Rate of Glym4 in Lactic Acid Bacteria>

A fermented soybean milk was prepared using lactic acid bacteria, Lactobacillus delbrueckii subsp. lactis KLAB-4 strain (hereinafter referred to as LAB4 strain), Lactobacillus helveticus K-4 strain (hereinafter referred to as K4 strain), and Pediococcus acidilactici R037 strain (hereinafter referred to as R037 strain), according to the preparation method of the fermented soybean milk described above. The decreasing rate of Glym4 in the fermented soybean milk was calculated according to the measurement method of decreasing rate of Glym4 described above. The results are shown in Table 1.

Lactobacillus delbrueckii subsp. lactis KLAB-4 strain was deposited at National Institute of Technology and Evaluation, Patent Microorganisms Depositary (NPMD), 2-5-8, Kazusakamatari, Kisarazu-shi, Chiba-ken, 292-0818, Japan, as an accession number NITE P-394 on Aug. 9, 2007 and transferred to international deposit under the provisions of the Budapest Treaty as an accession number NITE BP-394 on Sep. 22, 2008.

TABLE 1

| Lactic acid bacteria | Decreasing rate of Glym4 (%) |
|---|---|
| LAB4 strain | 0 |
| K4 strain | 40 |
| R037 strain | 80 |

From Table 1, the decreasing rate of Glym4 was found to vary depending on a type of the lactic acid bacteria used in the fermentation.

### (Example 2)<Leucine Aminopeptidase Activity of Lactic Acid Bacteria Used in Example 1>

Leucine aminopeptidase activities of the LAB4 strain, the K4 strain, and the R037 strain were measured according to the measurement method of the leucine aminopeptidase activity of the lactic acid bacteria described above. The results are shown in Table 2.

TABLE 2

| | Leucine aminopeptidase activity |
|---|---|
| Lactic acid bacteria | (unit) |
| LAB4 strain | 48.2 |
| K4 strain | 718.6 |
| R037 strain | 368.3 |

From Table 2, the LAB4 strain having a decreasing rate of Glym4 of 0% had a leucine aminopeptidase activity of 48.2 units, and the K4 strain having a decreasing rate of Glym4 of 40% had a leucine aminopeptidase activity of 718.6 units, and the R037 strain having a decreasing rate of Glym4 of 80% had a leucine aminopeptidase activity of 368.3 units.

### (Example 3)<Screening of Lactic Acid Bacteria Having Leucine Aminopeptidase Activity of 50 Units or More>

Using 20 strains of lactic acid bacteria separated from food materials as a subject, leucine aminopeptidase activity of each lactic acid bacteria was measured according to the measurement method of the leucine aminopeptidase activity of the lactic acid bacteria described above, and bacterial strains having a leucine aminopeptidase activity of 50 units or more, i.e., Pediococcus sp. 380 strain (hereinafter referred to as “380” strain), Pediococcus sp. 379 strain (hereinafter referred to as “379” strain), Streptococcus sp. 462 strain (hereinafter referred to as “462” strain), and Lactobacillus helveticus 28 strain (hereinafter referred to as “28” strain) were obtained. The leucine aminopeptidase activities of these four kinds of lactic acid bacteria strains are shown in Table 3.

TABLE 3

| Lactic acid bacteria | Leucine aminopeptidase activity (unit) |
|---|---|
| “380” strain | 77.4 |
| “379” strain | 166.1 |
| “462” strain | 588.6 |
| “28” strain | 593.3 |

### (Example 4)<Decreasing Rate of Glym4 in Lactic Acid Bacteria Screened in Example 3>

Using the “380” strain, “379” strain, “462” strain, and “28” strain, each fermented soybean milk was prepared according to the method of preparing the fermented soybean milk described above, and the decreasing rate of Glym4 was determined. The results are shown in Table 4.

TABLE 4

| Lactic acid bacteria | Decreasing rate of Glym4 (%) |
|---|---|
| “380” strain | 50 |
| “379” strain | 70 |
| “462” strain | 70 |
| “28” strain | 70 |

From Table 4, the “380” strain having a leucine aminopeptidase activity of 77.4 units had a decreasing rate of Glym4 of 50%, the “379” strain, the “462” strain, and the “28” strain, having, respectively, leucine aminopeptidase activities of 166.1 units, 588.6 units, and 593.3 units had all a decreasing rate of Glym4 of 70%.

Therefore, from the results of Examples 1 to 4, it was found that a lactic acid bacterium having leucine aminopeptidase activity of 75 units or more and less than 720 units has a decreasing rate of Glym4 of at least 40%.

### (Example 5)<Study on pH of Food During Fermentation>

Glucose and calcium carbonate were added to soybean milk prepared from commercially available dry soybean, to a respective concentration of 1% and 0.2% (20 mmol/L), and the mixture was sterilized at 90° C. for 15 minutes. Then, the R037 strain was inoculated to the sterilized mixture, and then the mixture was fermented at 37° C. for 24 hours with stirring while adjusting the pH to 5.5, 6.5, 7.5 or 8.5 to prepare a fermented soybean milk. The content of Glym4 in each fermented soybean milk that was prepared at the controlled pH was measured, which was compared to that of fermented soybean milk prepared in the same manner as above except that the pH control was not carried out. The results are shown in Table 5.

TABLE 5

| pH | Decreasing rate of Glym4 (%) |
|---|---|
| 4.4 | 20 |
| 5.5 | 80 |
| 6.5 | 80 |
| 7.5 | 80 |
| 8.5 | 10 |

From Table 5, it can be seen that Glym4 is decreased by setting the pH to 4.5 or more and less than 8.5, and in particular, when the pH is maintained at 5.5 to 7.5, the decreasing rate of Glym4 becomes 80%. Thus, it has been found that it is preferable to adjust the pH of the food-containing mixture to between 5.5 and 7.5 in the fermentation process.

### (Example 6)<Study of Fermentation Time and Sensory Evaluation>

Glucose and calcium carbonate were added, at respective concentrations of 1% and 0.6% (60 mmol/L), to commercially available unadjusted soybean milk and the mixture was sterilized at 90° C. for 15 minutes. The R037 strain was inoculated, and then the fermentation was performed with stirring at 37° C. for 8 hours, 12 hours, 24 hours, 36 hours, or 72 hours, whereby each fermented soybean milk was prepared.

The decreasing rate of Glym4 of each fermented soybean milk was calculated. In addition, each fermented soybean milk and soybean milk that was not fermented were subjected to the sensory evaluation as described above. The odor and the taste were evaluated according to a three-point method (x: poor, Δ: ordinary, ◯: good). The results of the decreasing rate of Glym4 and the sensory evaluation are shown in Table 6. The soybean milk having a decreasing rate of Glym4 of 40% or more and at least one of the “odor” and the “taste” of “◯” was evaluated as an accepted product.

TABLE 6

| | Fermentation | Decreasing rate | | |
|---|---|---|---|---|
| Raw material | time | of Glym4 | Odor | Taste |
| Commercially available | 0 h | 0 | ◯ | ◯ |
| unadjusted soybean milk | 8 h | 80 | ◯ | ◯ |
| | 12 h | 80 | ◯ | ◯ |
| | 24 h | 80 | ◯ | Δ |
| | 36 h | 80 | Δ | Δ |
| | 72 h | 90 | X | X |

From Table 6, it was found that when the commercially available unadjusted soybean milk was fermented for 8 hours, the decreasing rate of Glym4 was found to be 80%. In addition, as the result of the sensory evaluation, it was found that when the fermentation time was 8 hours to 24 hours, both or either of the odor and the taste of the fermented soybean milk was good.

### (Example 7)<Screening of Enzymes and Examination on Enzyme Treatment Conditions>

Commercially available proteases (5 kinds) per 1 g of protein were each added to a commercially available soybean drink (“Whole Soybean (Marugoto Daizu in Japanese)”, manufactured by Kagome Co., Ltd., solid content of soybean 14%) to have a concentration of 60 U/g, 300 U/g, and 1200 U/g. After enzyme treatment at 30° C. for 1 hour, the degree of decomposition of soybean protein was evaluated. The sensation of taste of the enzymatically decomposed product was also evaluated by 5 panelists. The results are shown in Table 7.

### <Evaluation for Decomposition Degree of Soybean Protein>

The decomposition of soybean protein was evaluated in accordance with the method described in the evaluation of the protein decomposition. Since the median molecular weight of the soybean liquid was 33 kDa, when the median molecular weight was about 17 kDa by enzyme treatment, it was judged that the enzyme treatment was carried out satisfactorily to decompose the soybean protein.

In addition, the degree of decomposition of soybean protein was evaluated according to the following criteria.

“Good”: The median molecular weight is 17 kDa or less.
“Slightly poor”: The median molecular weight is 18 to 28 kDa.
“Poor”: The median molecular weight is 29 kDa or more.

In the sensory evaluation, the evaluation was performed according to the following criteria.

“None”: No bitterness is felt (equivalent to commercially available soybean drinks)

“Somewhat”: Slight bitterness is felt.

“Yes”: Bitterness is felt.

“Strong”: Strong bitterness is felt.

TABLE 7

| | | Addition amount | | |
|---|---|---|---|---|
| | | of enzyme | Decomposition degree of | |
| Name of enzyme | Origin | U/g | protein | Bitterness |
| Protin SD-NY10 | Bacillus amyloliquiefacien | 60 | Slightly poor | None |
| | | 300 | Good | None |
| | | 1200 | Good | Yes |
| Thermoase C100 | Bacillus steareothermophilus | 60 | Poor | None |
| | | 300 | Good | None |
| | | 1200 | Good | Yes |
| Protease P3SD | Aspergillus melleus | 60 | Slightly poor | None |
| | | 300 | Good | None |
| | | 1200 | Good | Yes |
| Papain W-40 | Carica papaya L | 60 | Good | Strong |
| | | 300 | Good | Strong |
| | | 1200 | Good | Strong |
| Bromelain F | Ananas comosusu M. | 60 | Good | Strong |
| | | 300 | Good | Strong |
| | | 1200 | Good | Strong |

From Table 7, it is understood that the enzyme treatment with metalloproteases, Protin SD-N Y10, Thermoase C100 and Protease P3 SD, makes the degree of decomposition of soybean protein good and the bitterness of the enzymatically decomposed product is also removed.

On the other hand, when using papain W-40 and bromelain F, which are plant-derived cysteine proteases that are not metalloproteases, the bitter taste of the enzymatically decomposed product becomes stronger, although protein decomposition was good in both cases.

### Example 8

Next, a suitable enzyme treatment conditions were examined using three kinds of metalloproteases (Protin SD-NY10, Thermoase C100, and Protease P3SD) each showing good results in Examples 7.

That is, one of the three kinds of metalloproteases was added to a commercially available soybean drink (“Whole Soybean”, manufactured by Kagome Co., Ltd., soybean solid content: 14%) at 30 U/g, 100 U/g, 300 U/g or 600 U/g, and subjected to enzyme treatment at 30° C., 45° C., or 60° C. for 0.5 hour, 1 hour, 3 hours, or 4 hours, and the degree of decomposition of soybean protein was measured by SDS-PAGE according to the same criteria described above.

Further, sensory evaluation was also conducted by 5 panelists on the taste with the same criteria as in Example 7.

These results are shown in Table 8.

TABLE 8

| | Addition | | Enzyme | Decomposition | | | | Bitterness | | | |
|---|---|---|---|---|---|---|---|---|---|---|---|
| | amount of | | treatment | 0.5 | 1.0 | 3.0 | 4.0 | 0.5 | 1.0 | 3.0 | 4.0 |
| Enzymes | enzyme | | temperature | hour | hour | hours | hours | hour | hour | hours | hours |
| Protin SD- | 30 | U/g | 30° C. | Slightly | Slightly | Good | Good | None | None | None | None |
| NY10 | | | | poor | poor | | | | | | |
| | | | 45° C. | Good | Good | Good | Good | None | None | None | None |
| | | | 60° C. | Good | Good | Good | Good | None | None | None | None |
| | 100 | U/g | 30° C. | Good | Good | Good | Good | None | None | None | None |
| | | | 45° C. | Good | Good | Good | Good | None | None | None | None |
| | | | 60° C. | Good | Good | Good | Good | None | None | None | None |
| | 300 | U/g | 30° C. | Good | Good | Good | Good | None | None | None | None |
| | | | 45° C. | Good | Good | Good | Good | None | None | None | None |
| | | | 60° C. | Good | Good | Good | Good | None | None | None | None |
| | 600 | U/g | 30° C. | Good | Good | Good | Good | None | None | None | None |
| | | | 45° C. | Good | Good | Good | Good | None | None | None | Somewhat |
| | | | 60° C. | Good | Good | Good | Good | None | None | None | Somewhat |
| Thermoase | 30 | U/g | 30° C. | Slightly | Slightly | Good | Good | None | None | None | None |
| C100 | | | | poor | poor | | | | | | |
| | | | 45° C. | Good | Good | Good | Good | None | None | None | None |
| | | | 60° C. | Good | Good | Good | Good | None | None | None | None |
| | 100 | U/g | 30° C. | Good | Good | Good | Good | None | None | None | None |
| | | | 45° C. | Good | Good | Good | Good | None | None | None | Somewhat |
| | | | 60° C. | Good | Good | Good | Good | None | None | None | Somewhat |
| | 300 | U/g | 30° C. | Good | Good | Good | Good | None | None | None | None |
| | | | 45° C. | Good | Good | Good | Good | None | None | Somewhat | Yes |
| | | | 60° C. | Good | Good | Good | Good | None | None | Somewhat | Yes |
| | 600 | U/g | 30° C. | Good | Good | Good | Good | None | None | None | None |
| | | | 45° C. | Good | Good | Good | Good | None | None | Yes | Strong |
| | | | 60° C. | Good | Good | Good | Good | None | None | Yes | Strong |
| Protease | 30 | U/g | 30° C. | Slightly | Slightly | Good | Good | None | None | None | None |
| P3SD | | | | poor | poor | | | | | | |
| | | | 45° C. | Good | Good | Good | Good | None | None | None | None |
| | | | 60° C. | Good | Good | Good | Good | None | None | None | None |
| | 100 | U/g | 30° C. | Good | Good | Good | Good | None | None | None | None |
| | | | 45° C. | Good | Good | Good | Good | None | None | None | Somewhat |
| | | | 60° C. | Good | Good | Good | Good | None | None | None | Somewhat |
| | 300 | U/g | 30° C. | Good | Good | Good | Good | None | None | None | None |
| | | | 45° C. | Good | Good | Good | Good | None | None | Somewhat | Yes |
| | | | 60° C. | Good | Good | Good | Good | None | None | Somewhat | Yes |
| | 600 | U/g | 30° C. | Good | Good | Good | Good | None | None | None | None |
| | | | 45° C. | Good | Good | Good | Good | None | None | Yes | Strong |
| | | | 60° C. | Good | Good | Good | Good | None | None | Yes | Strong |

As shown in Table 8, when enzyme treatment is carried out using metalloproteases such as Protin SD-NY10, Thermoase C100 and Protease P3 SD, it has been found that the extent of decomposition and the taste of soybean protein vary depending on the amount of enzyme added and enzyme treatment temperature, but the suitable treatment time is 4 hours or less, especially 1 to 4 hours. In addition, it can be understood that the degree of decomposition of soybean protein is good and the bitterness of the enzymatically decomposed product does not occur, under the above treatment conditions.

### (Example 9)<Production Method 1 of Fermented Food Composition>

Based on the results obtained in Examples 1 to 8, conditions for producing a fermented food composition were examined by subjecting a soybean liquid to lactic acid fermentation, followed by enzyme treatment.

### (Inventive Product 1)

Lactobacillus R037 strain was added to a soybean drink (“Whole Soybean”, manufactured by Kagome Co., Ltd., soybean solid content: 14%), and lactic acid fermentation was carried out at 37° C. After confirming that the pH became 5.0 to 6.5, the fermented liquid was sterilized by heating at 80° C. for 30 minutes.

Subsequently, Protin SD-NY10, a metalloprotease, was added to the obtained lactic acid fermented product to a protein concentration of 100 to 600 U/g and enzymatically treated at 60° C. for 1 to 3 hours.

Thereafter, the enzyme was inactivated by heat treatment at 90° C. for 20 minutes to obtain a fermented food composition (fermented soybean liquid) (Inventive Product 1).

As the result of evaluating the decreasing rate of Glym4 of the Inventive Product 1, the decreasing rate of Glym4 was 80%, so that the Inventive Product 1 was found to be a fermented food composition having a reduced content of class-2 food allergens. Also, as the result of the sensory evaluation, the Inventive Product 1 had no bitterness and had good taste. In the Inventive Product 1 to which arginine was added, since there was no bitterness derived from arginine, it was found that the Inventive Product 1 is a fermented food composition capable of reducing bitterness derived from arginine. Furthermore, as the result of calculating the median value of the molecular weight of the Inventive Product 1, the median value of molecular weight of untreated soybean liquid (Comparative Product 3 to be described later) was 33 kDa, whereas the median value of molecular weight of the Inventive Product 1 was 15 kDa. Thus, it was found that the Inventive Product 1 is a fermented food composition excellent in digestive absorb ability.

### (Inventive Product 2)

A fermented food composition was obtained in the same manner as in the Inventive Product 1 except that the “28” strain was used for the fermentation of soybean liquid in lactic acid fermentation (Inventive Product 2). As for the Inventive Product 2, as the result of similar evaluation to the Inventive Product 1, the Inventive Product 2 was free from bitterness and had a good taste, and the Inventive Product 2 added with arginine had no bitterness derived from arginine. Thus, it was found that the Inventive Product 2 is a fermented food composition capable of reducing bitterness derived from arginine. Furthermore, as the result of calculating the median value of the molecular weight of the Inventive Product 2, it was 15 kDa, so that the Inventive Product 2 was found to be a fermented food composition superior in digestive absorbability of the decomposed soybean protein.

### Comparative Example 1

A lactic acid fermented product was obtained in the same manner as in Example 9 except that the enzyme treatment was not carried out (Comparative Product 1).

### Comparative Example 2

An enzymatically treated product was obtained in the same manner as in Example 9 except that the soybean liquid was enzymatically treated without performing lactic acid fermentation (Comparative Product 2).

### Comparative Example 3

Untreated soybean liquid was used as it was (Comparative Product 3).

Arginine (1 g, 5 g and 10 g) was added to 100 g of any one of Inventive Products 1 and 2 and Comparative Products 1 to 3, and after stirring the mixture, the pH was adjusted to 7.0 with citric acid to prepare arginine-mixed soybean liquids. The sensation of bitterness of arginine in each mixed soybean liquid was evaluated by 5 panelists.

In the sensory evaluation, the evaluation was made according to the following criteria.

“◯”. No bitterness due to the addition of arginine is felt.

“Δ”: Slight bitterness due to the addition of arginine is felt.

“×”: Bitterness due to the addition of arginine is felt.

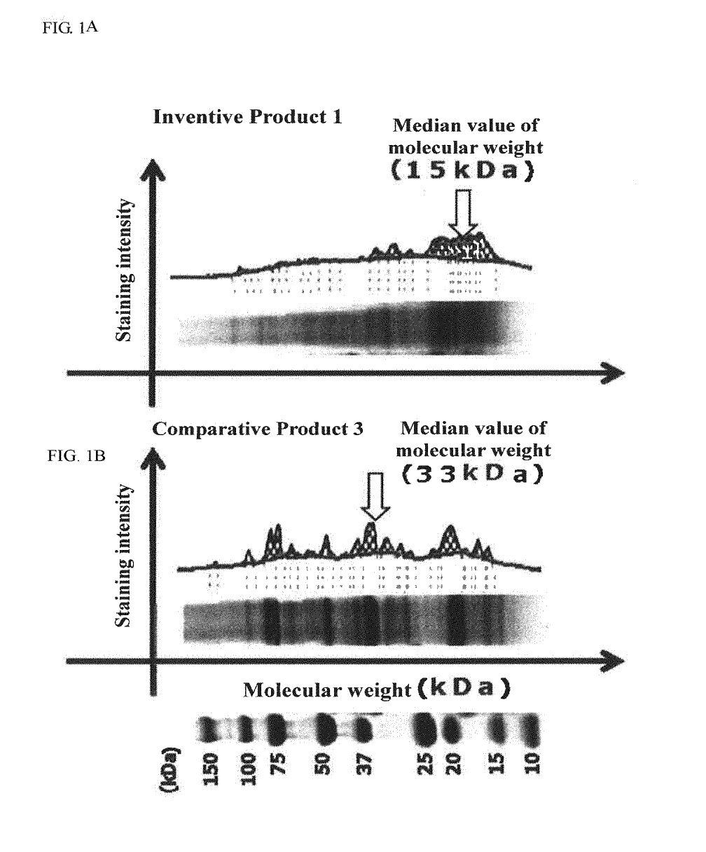

At the same time, by subjecting the Inventive Products 1 and 2 and Comparative Products 1 to 3 to SDS-PAGE and calculating the median value of the molecular weight of soybean protein, the degree of decomposition of the soybean protein was evaluated according to the method described in the evaluation of decomposition of the above proteins. Here, FIG. 1 illustrates the results of gel staining and densitogram of SDS-PAGE of the Inventive Product 1 and Comparative Product 3. In FIG. 1, the horizontal axis of the densitogram shows the molecular weight (kDa), the vertical axis shows the staining intensity (concretely, the protein's band density in SDS-PAGE), and each peak area shows the band. Then, the value obtained by adding the peak area of each band excluding the staining intensity which is the background is taken as the total staining intensity area. Then, when the total staining intensity area is taken as 100%, the peak area of the larger molecular weight (or from the smaller one) is added in order, and the molecular weight at which the total staining intensity area is 50% is defined as a median value of the molecular weight. As shown in FIG. 1, when the total staining intensity area of the Inventive Product 1 is taken as 100%, the molecular weight when each peak area is added in order and becomes 50% of the total staining intensity area is 15 kDa, which was calculated as the median value of the molecular weight in the Inventive Product 1. In addition, similarly to the Inventive Product 1, for the Comparative Product 3, the peak area was added to calculate the molecular weight which became 50% of the total staining intensity area. As the result, the molecular weight was 33 kDa and was taken as the median value of the molecular weight in Comparative Example 3. As for the Inventive Product 2 and Comparative Products 1 and 2, the median value of each molecular weight was calculated using the results of gel staining and densitogram of SDS-PAGE in the same manner as in the Inventive Product 1 and Comparative Product 3.

Table 9 shows the median value of the separated samples of soybean proteins and the results of sensory evaluation in each of the products (Inventive Products 1 to 2, and Comparative Products 1 to 3).

TABLE 9

| | |
|---|---|
| Median value of | Sensory evaluation |

| | molecular weight | 1 g | 5 g | 10 g |
|---|---|---|---|---|
| Inventive Product 1 | 15 kDa | ◯ | ◯ | ◯ |
| Inventive Product 2 | 15 kDa | ◯ | ◯ | ◯ |
| Comparative Product 1 | 28 kDa | ◯ | ◯ | ◯ |
| Comparative Product 2 | 15 kDa | Δ | Δ | X |
| Comparative Product 3 | 33 kDa | Δ | Δ | X |

It can be seen from the results of Table 9 that even if arginine was added to the Inventive Products 1 and 2 that had been subjected to lactic acid fermentation and enzyme treatment, the bitterness of arginine was reduced and also shows excellent digestive absorbability of soybean proteins into the body because the soybean proteins were decomposed.

On the other hand, it is revealed that in Comparative Product 1 not subjected to enzyme treatment, the bitterness of arginine is reduced, but the median value of the molecular weight of soybean protein is larger than that of each of the Inventive Products 1 and 2, so that digestive absorbability into the body is poor.

Further, it is found that in Comparative Product 2 not subjected to lactic acid fermentation, although the median value of the molecular weight of soybean protein is low, the effect of masking the bitterness of arginine is weak.

In Comparative Product 3 not subjected to lactic acid fermentation and enzyme treatment, the effect of masking the bitterness of arginine was weak, and the median value of the molecular weight of soybean protein was also the largest.

From the above, it is understood that the fermented food composition obtained according to the present invention has an effect of reducing the bitterness of arginine and is excellent in digestive absorbability of proteins into the body.

### (Example 10)<Production Method 2 of Fermented Food Composition>

A fermented food composition was produced by subjecting soybean liquid to enzyme treatment, followed by lactic acid fermentation.

Specifically, Protin SD-NY10 was added to a soybean drink (“Whole Soybean”, manufactured by Kagome Co., Ltd., solid content of soybean 14%) to a concentration of 100 to 600 U/g protein and the mixture was subjected to the enzyme treatment at 60° C. for 1 to 3 hours.

Thereafter, the mixture was heated at 90° C. for 20 minutes to inactivate the enzyme; R037 strain or “28” strain was added thereto; lactic acid fermentation of the mixture was carried out at 37° C.; and after confirmation that the pH reached 5.0 to 6.5, the mixture was subjected to the sterilization under heating at 80° C. for 30 minutes to produce a fermented food composition (fermented soybean liquid) (Inventive Products 3 and 4).

The Inventive Products 3 and 4 were examined in the same manner as the Inventive Products 1 and 2 and were found to be fermented food compositions which have reduced class-2 food allergens, good taste, and reduced bitterness derived from arginine, and are excellent in digestive absorbability.

### Accession Number

FERM BP-12249, NITE BP-394, NITE BP-900, NITE BP-01773, NITE BP-01772, NITE BP-01771, NITE BP-02154

1. A method for producing a fermented food composition by fermenting a food having a class-2 food allergen, the method comprising:
adding lactic acid bacteria having leucine aminopeptidase activity of 75 or more and 720 or less units, to a food having a class-2 food allergen, and fermenting the food while adjusting a pH of a mixture including the food to 4.0 or more and less than 8.5; and
enzymatically treating the resulting mixture with a metalloprotease.

2. The method according to claim 1, wherein the enzymatically treating is performed before the fermenting or after the fermenting.

3. The method according to claim 1, wherein the metalloprotease is an endo-type metalloprotease.

4. The method according to claim 3, wherein the endo-type metalloprotease is derived from a filamentous fungus or from a bacterium.

5. The method according to claim 4, wherein the filamentous fungus belongs to the genus Aspergillus and the bacterium belongs to the genus Bacillus.

6. The method according to claim 1, wherein a time for the enzymatically treating is 4 hours or less.

7. The method according to claim 1, wherein an amount of an enzyme to be added during the enzymatically treating is 10 U/g or more and 1200 U/g or less per protein weight in the food having the class-2 food allergen.

8. The method according to claim 1, wherein the lactic acid bacteria are at least one type of bacteria selected from the group consisting of lactic acid bacteria each belonging to the genera Lactobacillus, Lactococcus, Leuconostoc, Pediococcus, and Enterococcus.

9. The method according to claim 1, wherein the class-2 food allergen includes an amino acid sequence having at least 20% sequence identity with an amino acid sequence of BetV1 and/or BetV2.

10. The method according to claim 1, wherein the food having the class-2 food allergen is a soybean and/or a soybean processed food.

11. A method for reducing bitterness of arginine by adding, to 1 mg of arginine, 5 mg or more and 1000 mg or less of the fermented food composition obtained by the production method as set forth in claim 1.

12. A food and drink containing 5 mg or more and 1000 mg or less of the fermented food composition obtained by the method as set forth in claim 1, relative to 1 mg of arginine.
